(19) United States
(12) Patent Application Publication
(10) Pub. No.: US 2012/0221561 A1
(43) Pub. Date: Aug. 30, 2012

(54) COMPUTER SYSTEM, DATABASE AND USES THEREOF

(75) Inventors: Scott BROWN, London (GB); Nick Jewell, London (GB)

(73) Assignee: HSBC Bank plc, London (GB)

(21) Appl. No.: 13/102,474

(22) Filed: May 6, 2011

(30) Foreign Application Priority Data
Feb. 28, 2011 (GB) 1103382.6

(51) Int. Cl. G06F 17/30; G06F 7/00

(52) U.S. Cl. 707/725; 707/723; 707/802; 707/E17.014; 707/E17.044

(57) ABSTRACT

A computer system is described comprising one or more servers, one or more user terminals; and a database of computer entries, each computer entry including node data defining a node representative of an entity and link data defining a plurality of links connecting the node to one or more other nodes representative of one or more other entities, each link having associated tag data that describes an attribute of one of the entities associated with the link and a reputational score associated with the attribute. The computer system is able to search the computer entries based on a search request; to rank search results based on reputational scores associated with the search results; and to output one or more ranked search results. The computer system also allows entities to add new links into the database and to add new nodes representing new entities into the database.

This application claims priority to UK Patent Application No. 1103382.6, filed Feb. 28, 2011, the entire contents of which is expressly incorporated herein by reference.

The present invention relates to a computer system, a database and methods of use thereof. The invention has particular relevance to a database structure that maintains data defining relationships between entities that can be used, among other things, for reputation and knowledge management.

Businesses throughout the world maintain databases that store data describing individual employees and their working relationship to others within the business. Typically, existing systems maintain a database record for each employee defining their role in the organisation and the groups to which they belong etc. Many of these computer systems also rely on the employee to create or fill in a standard company record and the amount of information entered varies dramatically between employees; with extroverted employees typically providing much more information than introverted employees. One of the purposes of maintaining this information is so that others in the organisation are able to search the database to find an expert on a particular subject on which they are currently working. In an ideal world this would be easy to achieve using the company database, but in practice significant time is wasted when an “expert” turns out not actually to have the required knowledge or expertise and a further search has to be performed. Another difficulty is that as the organisation grows, the number of experts identified in a search can result in further time being spent deciding on which expert to use.

The problem is not limited to searching within company databases. Similar problems are faced when searching any large collection of data—such as websites on the Internet. The volume of data means that a search can result in thousands if not millions of “hits” making it almost impossible for the user to sift through all possible hits to find the most relevant. Existing Internet searching companies, such as Google, make a significant portion of their revenue by charging companies so that they will appear higher up the list of hits that are displayed to the searching user. So in the end the user often identifies the user or company who has paid the most to the searching company rather than the most appropriate user or company relating to their search.

What is needed, therefore, is a new database and computer system that can allow the more accurate accumulation of data and that can facilitate more accurate searching by end users.

### SUMMARY OF INVENTION

According to one aspect, the present invention provides a computer system comprising: a computer server; one or more user terminals; and a database of computer entries, each computer entry including node data defining a node representative of an entity and link data defining a plurality of links connecting the node to one or more other nodes representative of one or more other entities, each link having associated tag data that describes an attribute of one of the entities associated with the link and a reputational score associated with the attribute. The is operable: i) to receive a search request; ii) to search the computer entries based on the received search request; iii) to rank search results based on reputational scores associated with the search results; and iv) to output one or more ranked search results.

In a preferred embodiment, each reputational score has an associated time dependent weighting (different from the weighting applied to other reputational scores). The weighting applied to a reputational score can be set to reduce the reputational score relative to other weighted reputational scores and may be defined by one or more exponential functions. The weighting applied may depend on the difference in time between when the search request is received and when that reputational score was last updated. The weighting may be determined by the server, the database or the user terminal.

In one embodiment, the weighting applied to a reputational score depends on the entity represented by the node to which the link associated with the reputational score extends. For example, where entities are able to create links with other entities in the database, the weighting applied to a reputational score may depend on the number of links created in a given time period by the entity represented by the node to which (or in some cases from which) the link associated with the reputational score extends. The weighting that is applied preferably reduces as the number of links created in the given time period by the entity increases.

In one embodiment, where the reputational scores are weighted, a constant weighting or no weighting is applied to a reputational score during an initial period following an update of the reputational score. The initial period may be, for example, a day, week or month etc.

The weighting applied to a reputational score is preferably such that the reputational score is substantially reduced to zero after a defined period, such as twelve months, following the time that the reputational score was last updated.

The weighting that is applied to the reputational score may be multiplied with the reputational score; or the reputational score may be divided by the weighting; or the reputational score may be weighted by subtracting the weighting from or adding the weighting to the reputational score.

In one embodiment entities are able to vote on the reputational scores stored within the database. Preferably, an entity associated with a node from which, or to which, a link associated with a reputational score extends, is prevented from voting on that reputational score. The prevention may be controlled by the server, the database or a user terminal and can be controlled using login data associated with the voting entity. Likewise, votes that are received may be used by the server or the database to update the reputational score. The reputational score may be voted up or voted down and a limit may be placed on the amount by which a given entity can vote up the reputational score. The database can maintain vote data for votes that have been made on reputational scores by an entity and a check may be made on previous votes made by the voting entity to determine if the limit has been reached and thereby whether or not the reputational score should be updated in accordance with the vote. In one embodiment, voting entities are limited in an amount that they can vote down a reputational score to the amount that the voting entity has previously voted up the reputational score. In the preferred embodiment, each reputational score has an associated time stamp that indicates the last time that the reputational score was updated and the time stamp is updated in response to the voting up or the voting down of the reputational score.

The node data stored in the database for an entity may include one or more of: a node ID for the entity; a name for the entity and contact details for the entity. The node ID preferably comprises a Universal Resource Identifier, URI—as this facilitates the widespread adoption of the database.

The link data stored in the database for each link may include from node data identifying the node from which the link extends and to node data identifying the node to which the link extends and a tag ID that identifies tag data associated with the link. The tag data associated with a link may include a tag ID and a tag description. The tag description may relate to an attribute (an area of expertise) of the entity associated with the node to which the link extends and the description is defined by the entity associated with the node from which the link extends.

In one embodiment, new node data can be stored in the database to represent new entities and new link data can be stored in the database to represent new relationships between existing entities or between new entities and existing entities or between new entities. The new node data may be generated by the server or database in response to user inputs received from one or more user terminals.

The invention also provides a computer server comprising: a processor operable to: receive a search request from a user terminal; search a database of computer entries based on the received search request, the database storing, for each computer entry, node data defining a node representative of an entity and link data defining a plurality of links connecting the node to one or more other nodes representative of one or more other entities, each link having associated tag data that describes an attribute of one of the entities associated with the link and a reputational score associated with the attribute; rank search results based on reputational scores associated with the search results; and output one or more ranked search results to the user terminal.

The invention also provides a database comprising: a plurality of computer entries, each computer entry including: node data defining a node representative of an entity; and link data defining a plurality of links connecting the node to one or more other nodes representative of one or more other entities, each link having associated tag data that describes an attribute of one of the entities associated with the link and a reputational score associated with the attribute.

The invention also provides a method of searching the above database, characterised by ranking search results using reputational scores associated with links matching a search query. The method preferably weights the reputational scores prior to the ranking.

The database described herein can be used in various commercial applications ranging from internet searches, social networking, office administration etc.

The invention also provides a computer terminal comprising: a processor operable to: receive a search request; search a database of computer entries based on the received search request, the database storing, for each computer entry, node data defining a node representative of an entity and link data defining a plurality of links connecting the node to one or more other nodes representative of one or more other entities, each link having associated tag data that describes an attribute of one of the entities associated with the link and a reputational score associated with the attribute; rank search results based on reputational scores associated with the search results; and output one or more ranked search results to the user.

The invention also provides a computer system comprising: a computer server; and a database of computer entries, each computer entry including node data defining a node representative of an entity and link data defining a plurality of links connecting the node to one or more other nodes representative of one or more other entities, each link having associated tag data that describes an attribute of one of the entities associated with the link and a reputational score associated with the attribute; wherein the system is operable: i) to receive a request to add a link from a first entity to a second entity; ii) to receive a description of an attribute of the second entity; iii) to initialise a reputational score associated with the new link; iv) to define tag data for the new link based on the received description of the attribute of the second entity; and v) to store link data for the new link in the database. Defining new tag data may involve generating new tag data or using existing tag data if the tag already exists.

These and other aspects of the invention will become apparent from the following detailed description of embodiments which are described by way of example only with reference to the accompanying drawings in which:

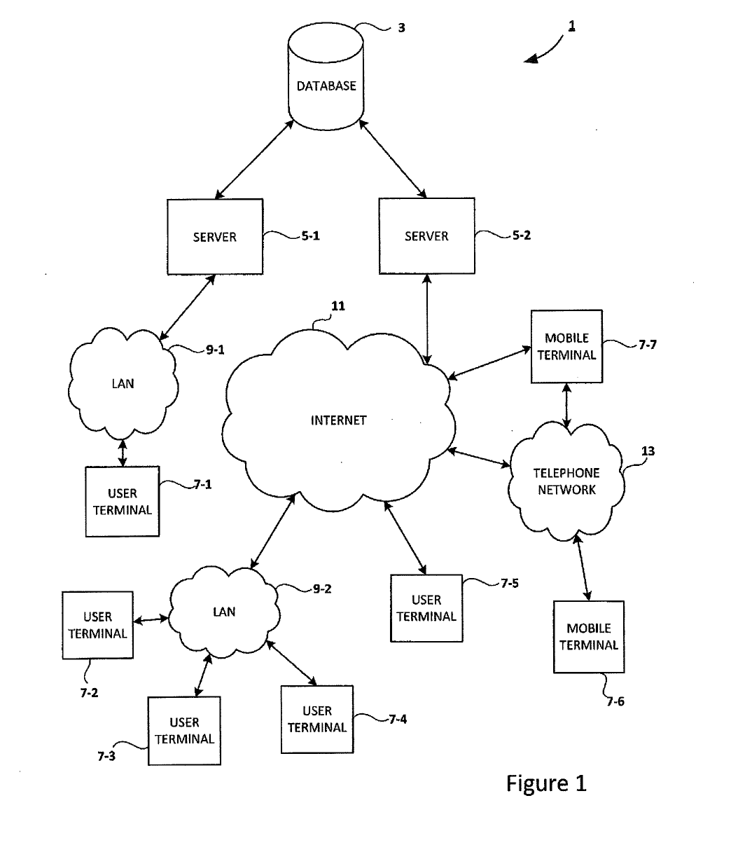

FIG. 1 is a block diagram illustrating a computer system in which the invention can be implemented;

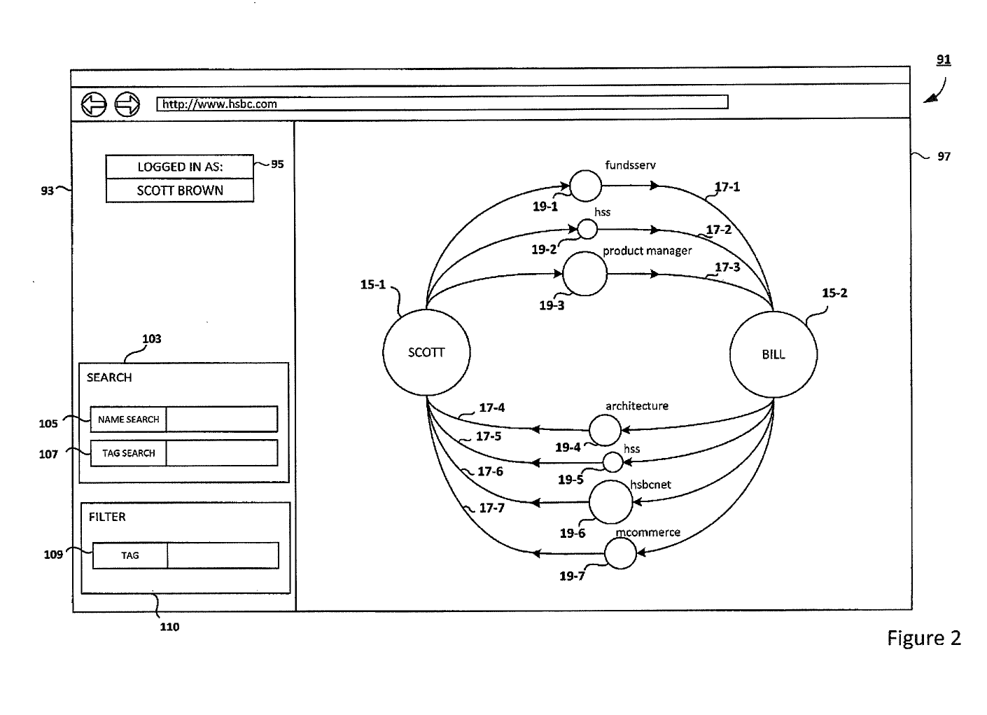

FIG. 2 illustrates a connected graph connecting two nodes representing entities stored in a database forming part of the system shown in FIG. 1;

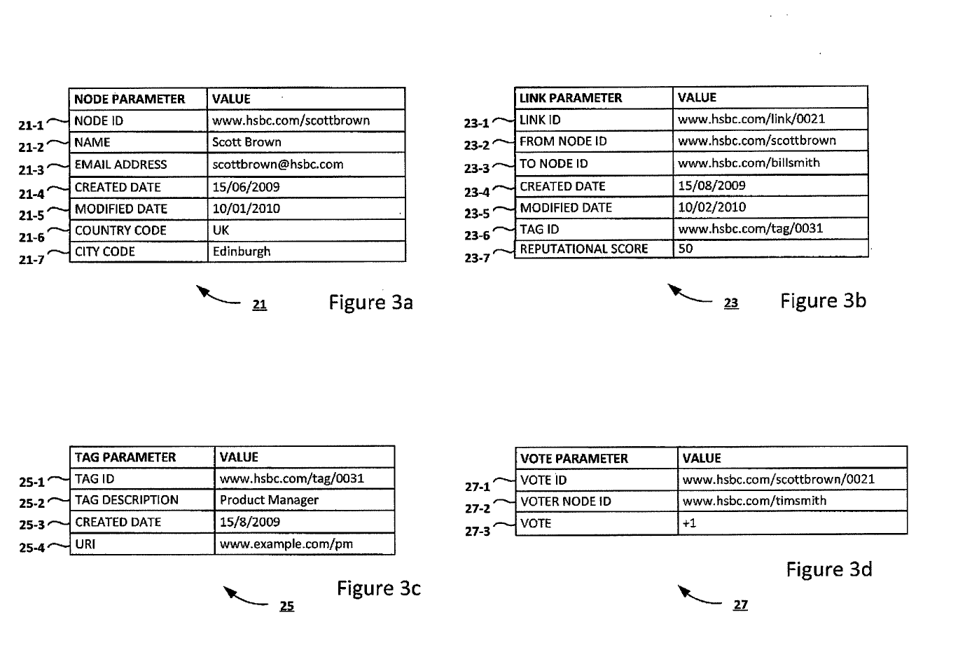

FIG. 3a illustrates the information maintained in the database associated with a node that corresponds to an entity;

FIG. 3b illustrates the information maintained in the database associated with a link that connects two nodes and that defines a relationship between the entities corresponding to the nodes;

FIG. 3c illustrates tag information maintained in the database that is associated with a link; and

FIG. 3d illustrates vote information maintained in the database for a vote made against a link that modifies a reputational score associated with the link;

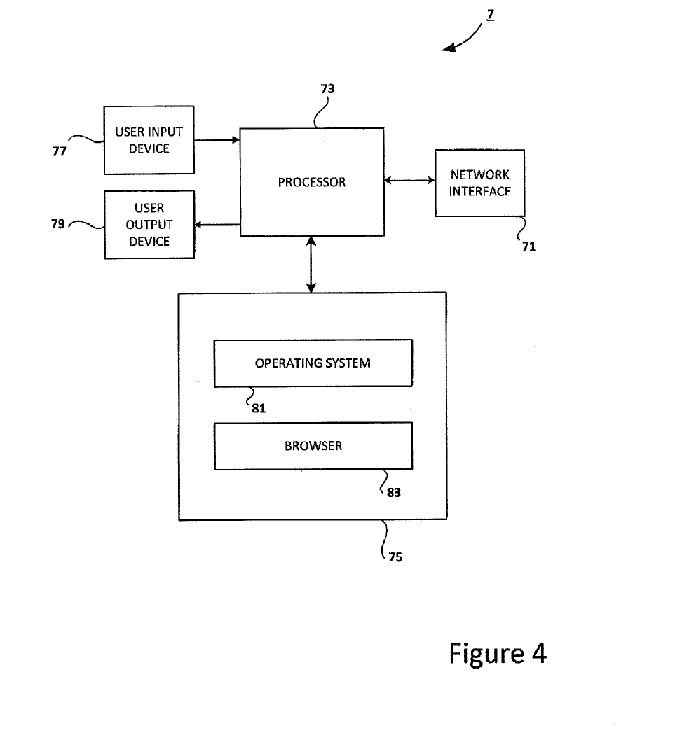

FIG. 4 is a block diagram illustrating the main components of a user terminal forming part of the system shown in FIG. 1;

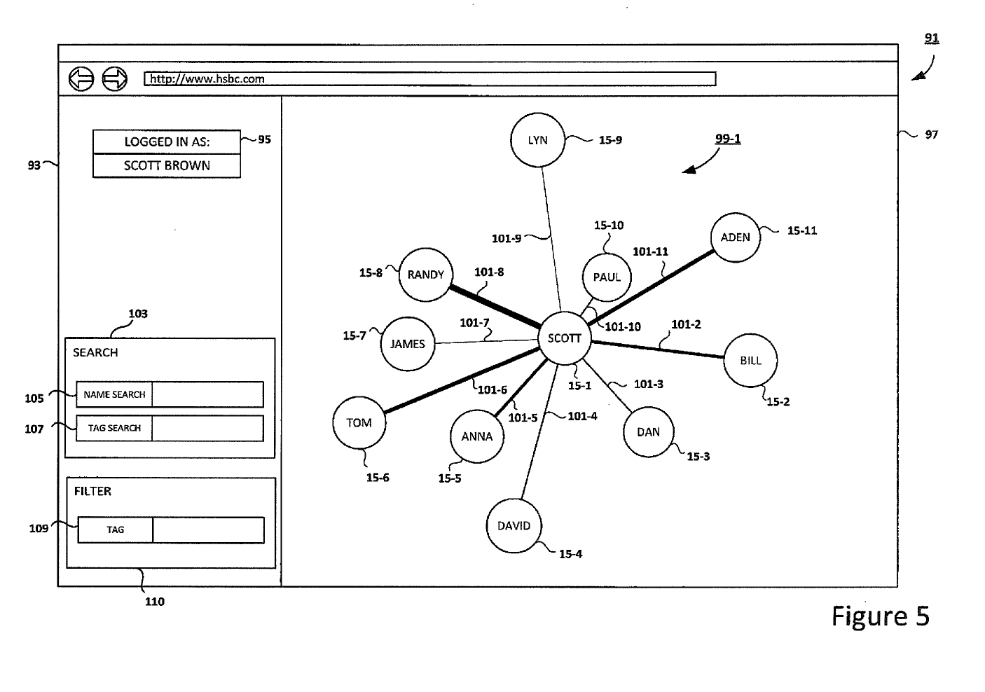

FIG. 5 illustrates a web browser interface generated on a display of the user terminal shown in FIG. 4 and graphically illustrating part of the data maintained in the database that relates to a currently logged-in user of the user terminal;

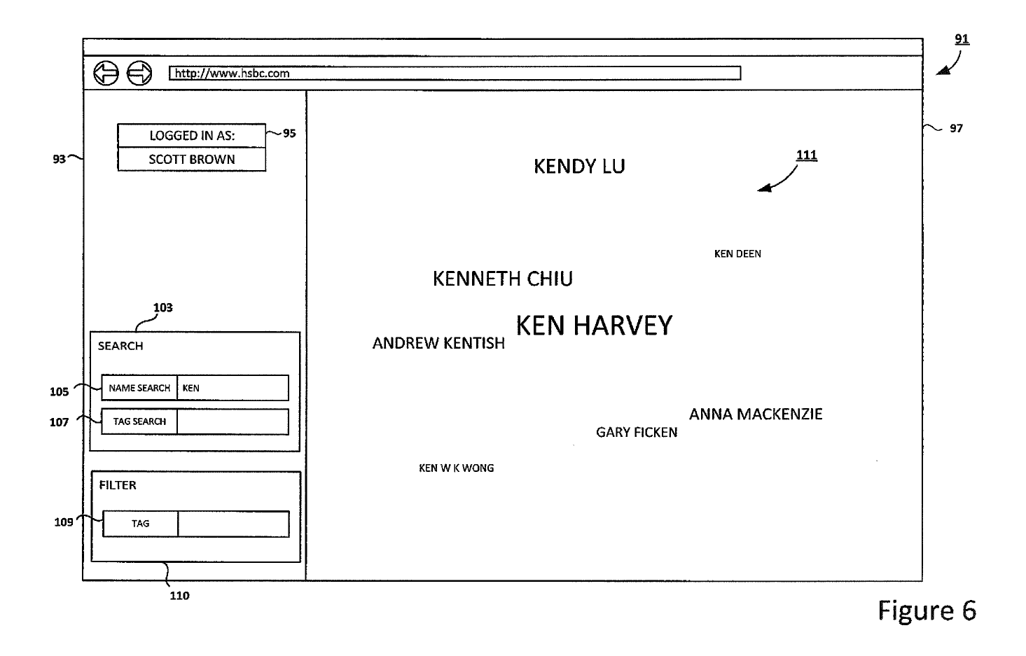

FIG. 6 illustrates a web browser interface generated on the display of the user terminal and graphically illustrating the way in which search results for a name search are displayed to a user;

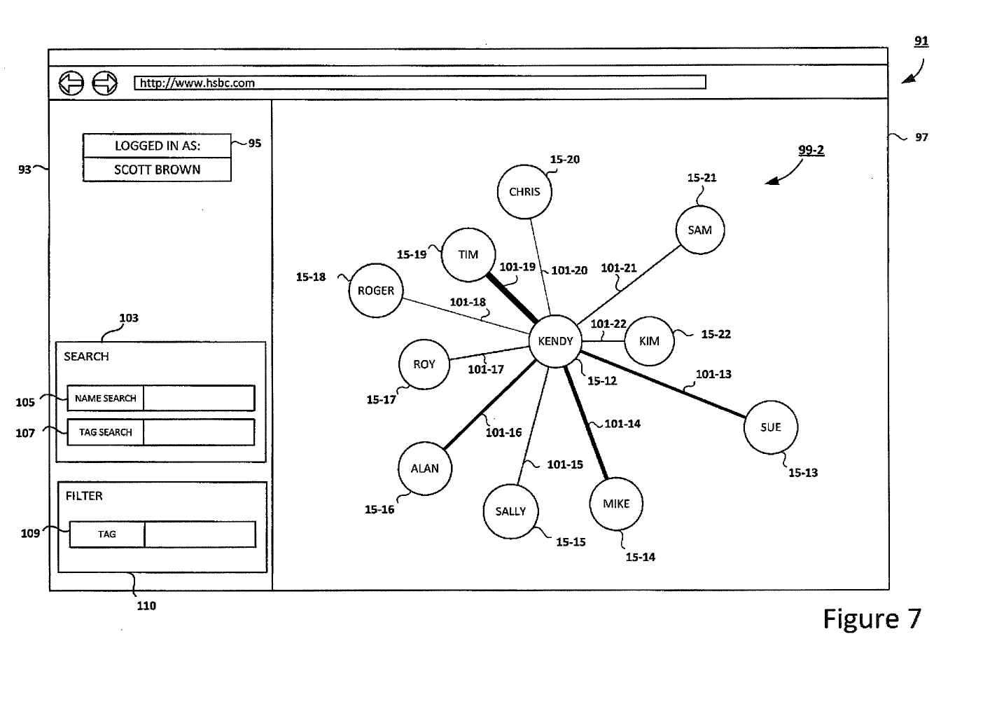

FIG. 7 illustrates a web browser interface generated on the display of the user terminal and graphically illustrating part of the data maintained in the database that relates to a name selected from the search results shown in FIG. 6;

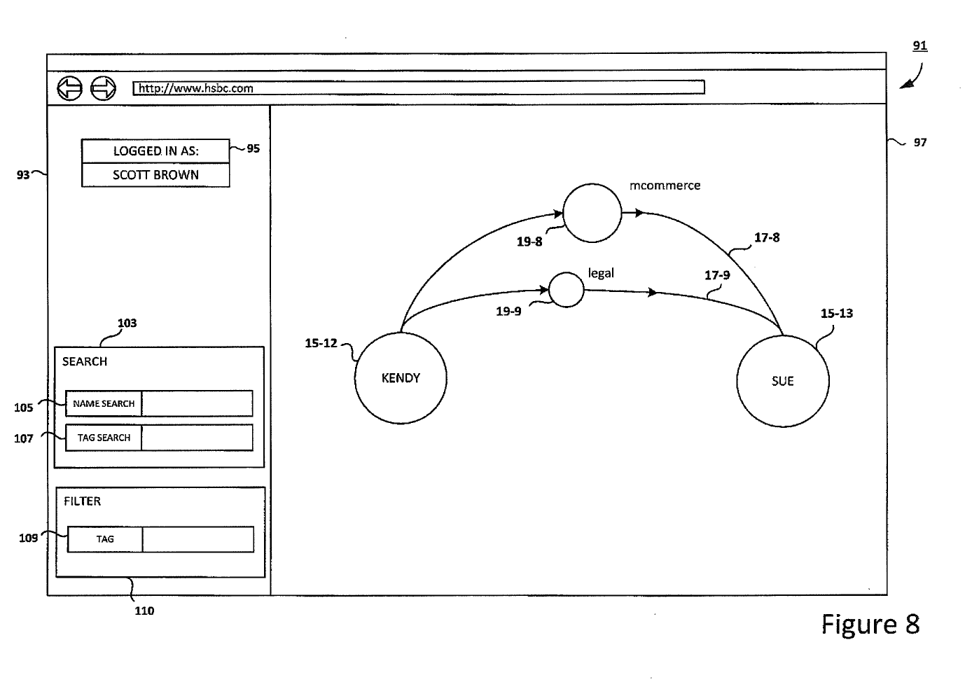

FIG. 8 illustrates a connected graph connecting two nodes representing entities illustrated in the graph shown in FIG. 7;

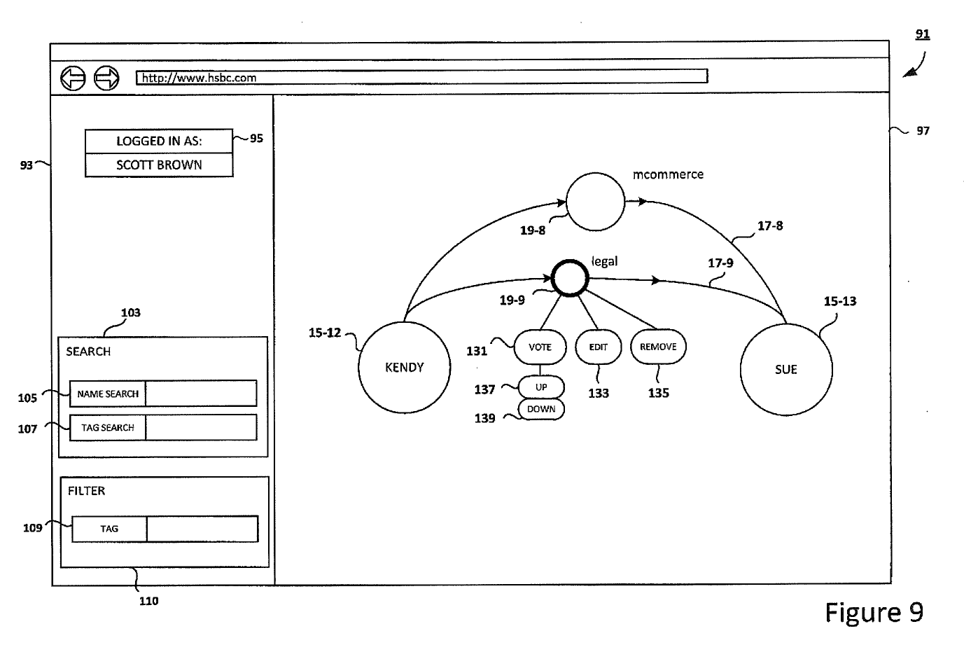

FIG. 9 illustrates the connected graph shown in FIG. 8 after the user selects a tag illustrated in the graph;

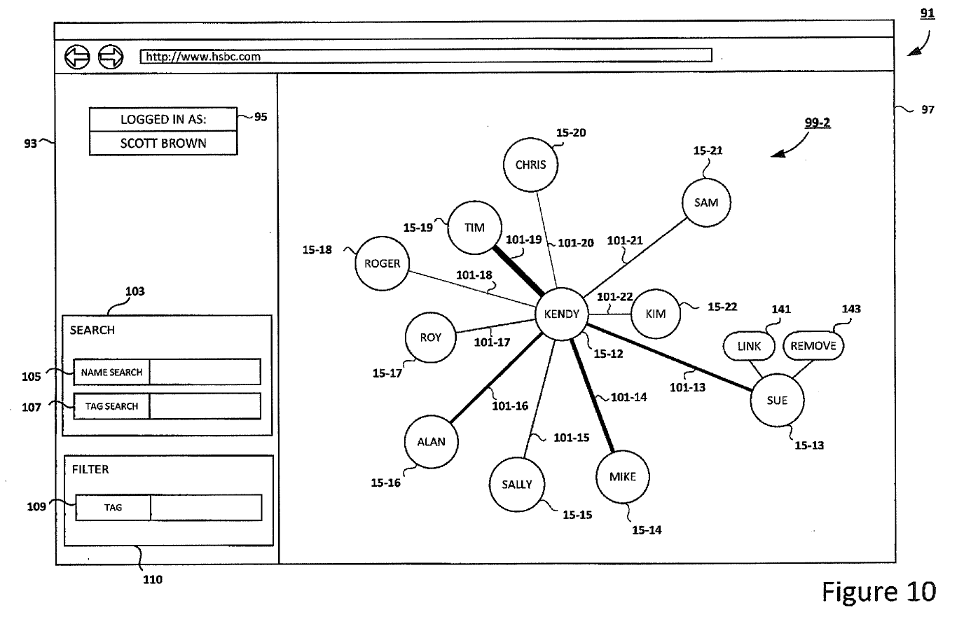

FIG. 10 illustrates a web browser interface generated on the display of the user terminal and graphically illustrating the data shown in FIG. 7 when a node is selected by the user;

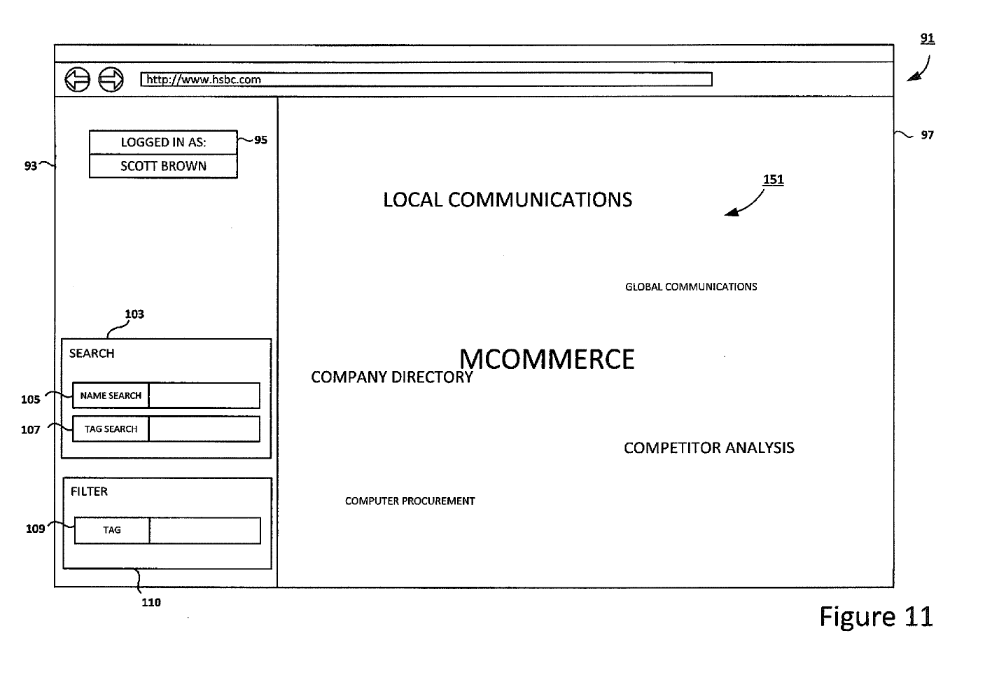

FIG. 11 illustrates a web browser interface generated on the display of the user terminal and graphically illustrating the way in which search results for a tag search are displayed to a user;

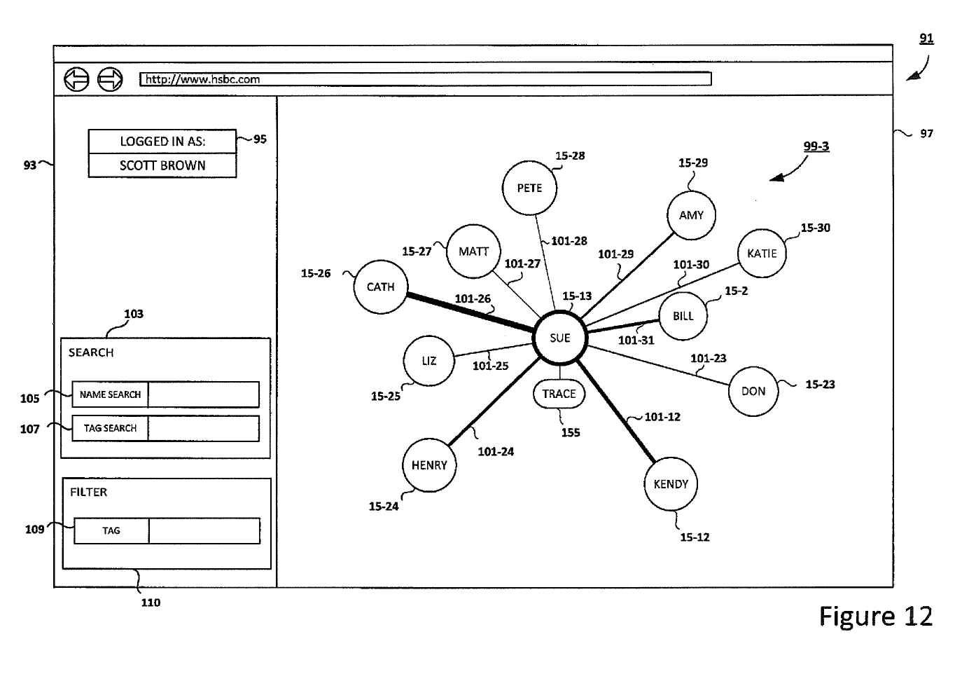

FIG. 12 illustrates a web browser interface generated on the display of the user terminal and graphically illustrating part of the data maintained in the database that relates to an expert user relating to a tag selected from the search results shown in FIG. 11;

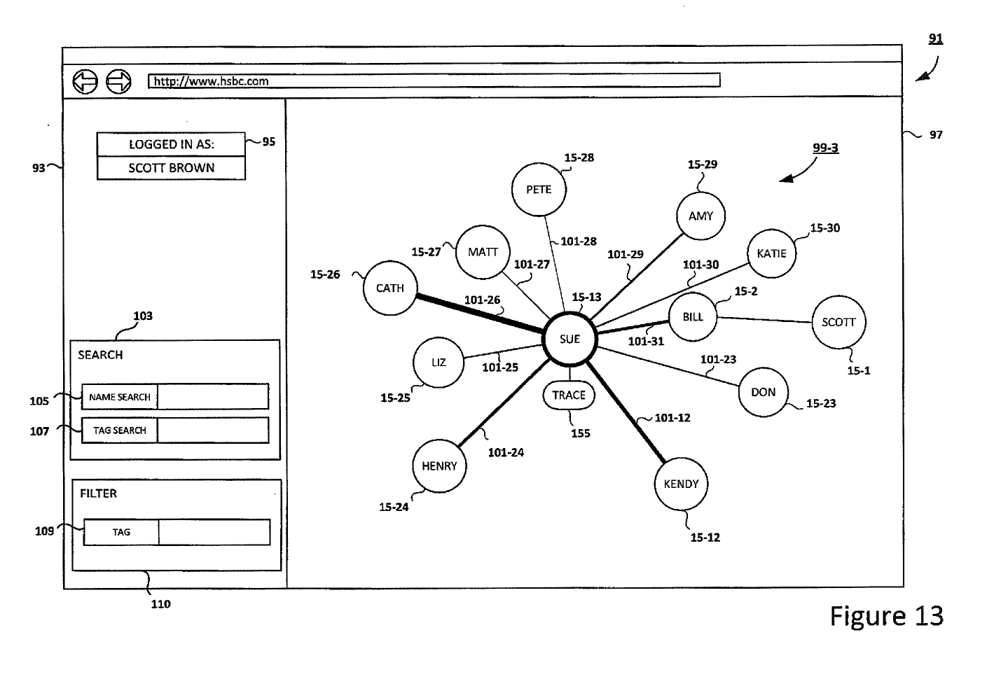

FIG. 13 illustrates a web browser interface generated on the display of the user terminal and graphically illustrating the part of the data maintained in the database shown in FIG. 12 and showing intermediate connections between the logged-in user and the identified expert user;

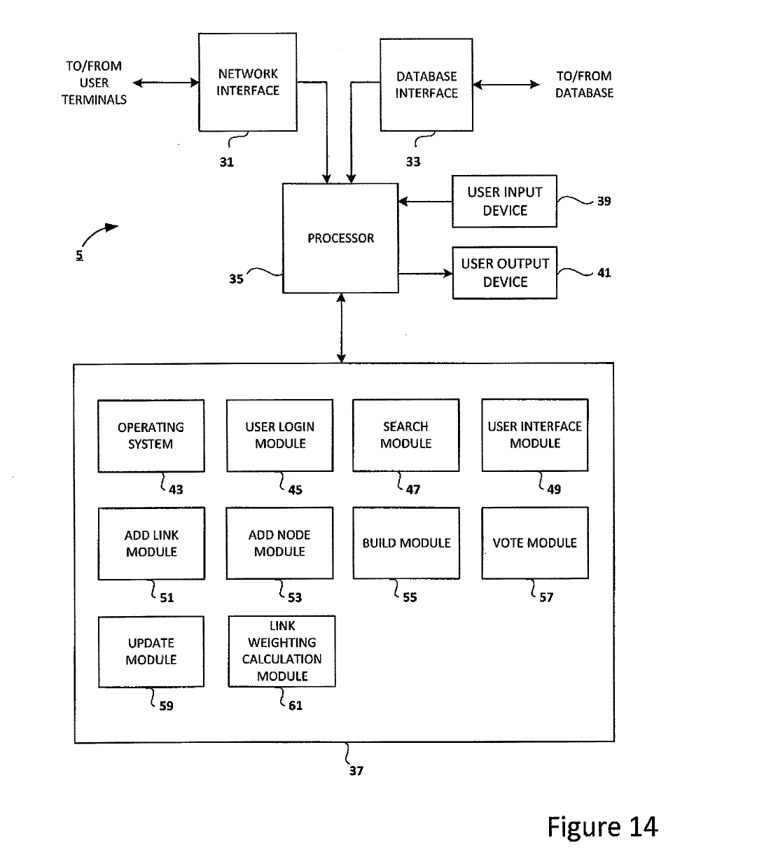

FIG. 14 is a block diagram illustrating the main components of a server forming part of the computer system shown in FIG. 1;

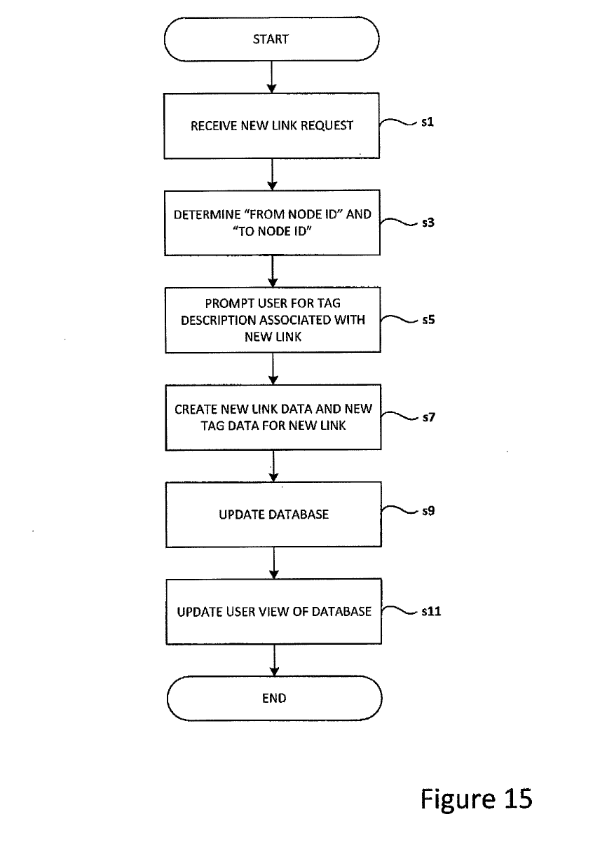

FIG. 15 is a flow chart illustrating the way in which the server shown in FIG. 14 creates a new link between two entities within the database;

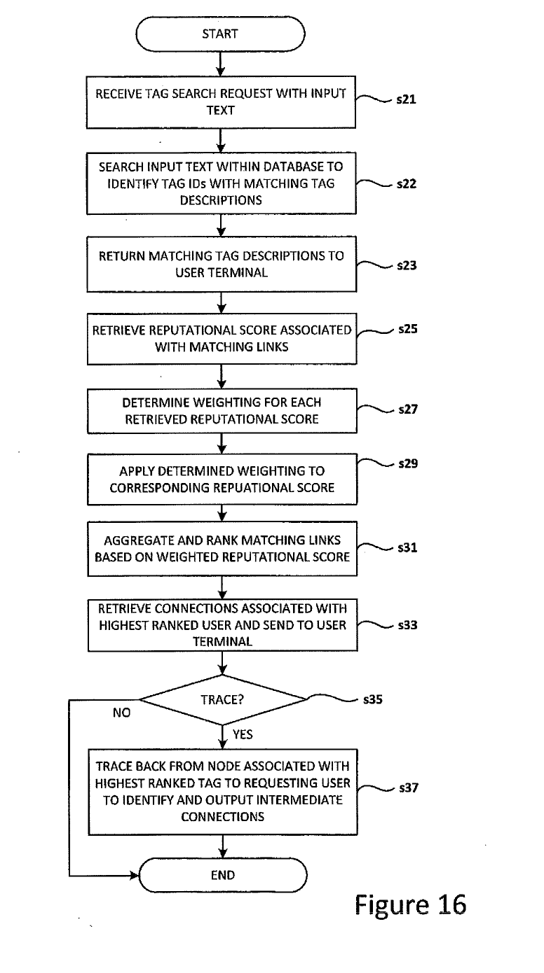

FIG. 16 is a flow chart illustrating the way in which the server shown in FIG. 14 performs a tag search within the database to identify an expert relating to a user specified tag description;

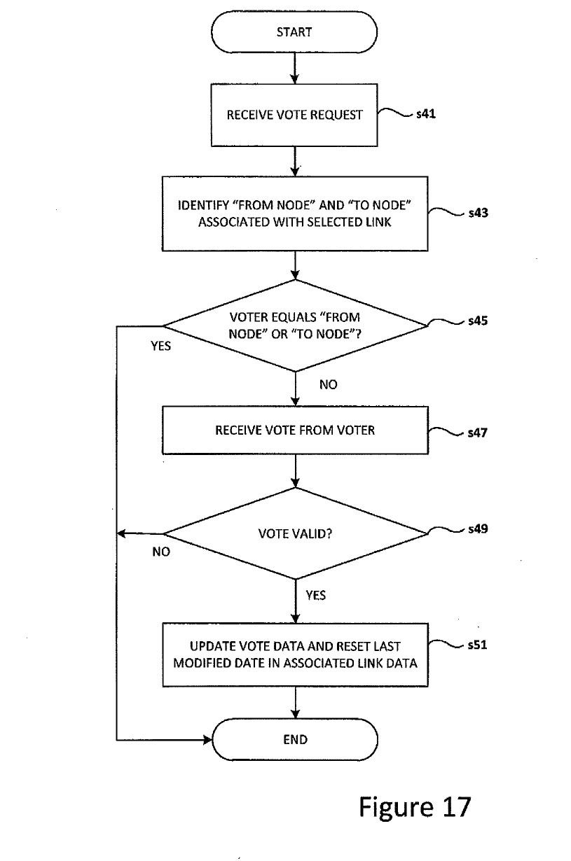

FIG. 17 is a flow chart illustrating the way in which the server sown in FIG. 14 changes the reputational score of the links on which votes have been made by other users;

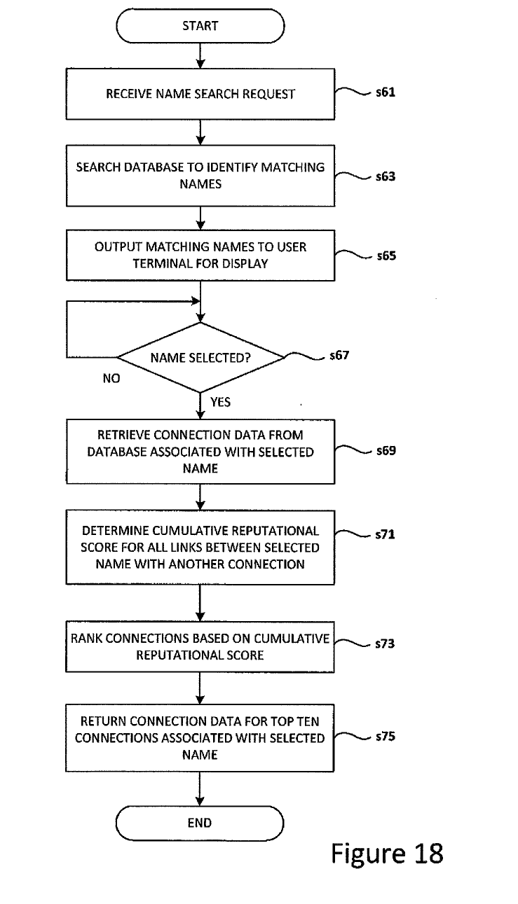

FIG. 18 is a flow chart illustrating the way in which the server shown in FIG. 14 performs a name search in response to receiving a name search request from a user terminal;

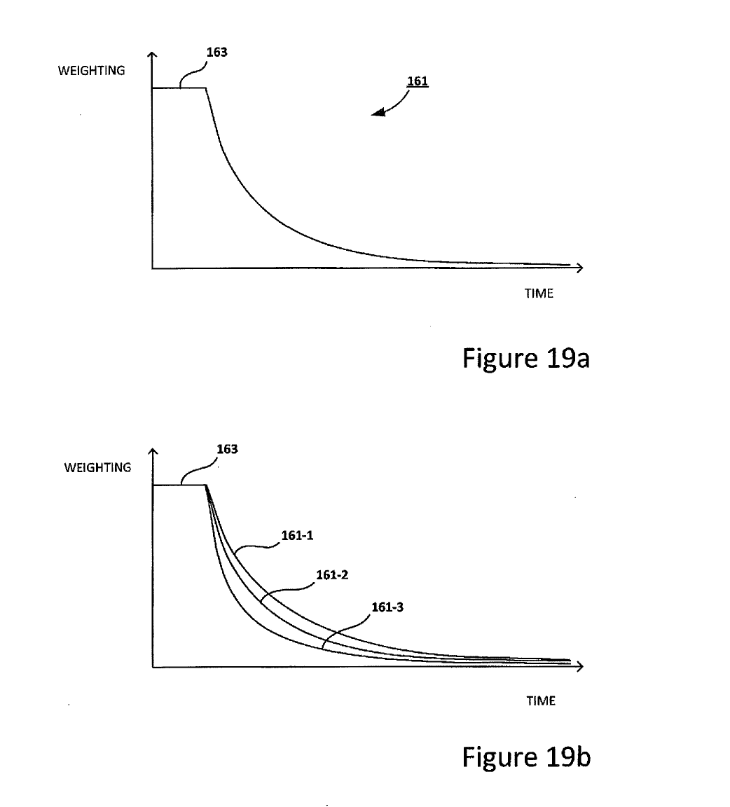

FIG. 19a is a plot illustrating a weighting function that is applied by the server shown in FIG. 14 to the reputational score associated with a link;

FIG. 19b illustrates alternative weighting functions that can be applied by the server shown in FIG. 14 to the reputational score associated with the link;

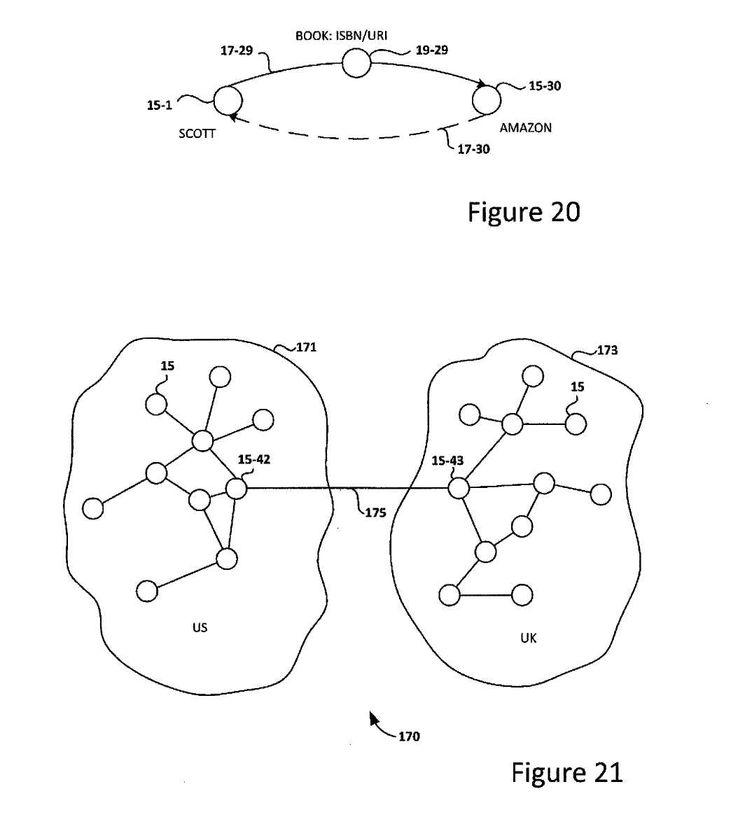

FIG. 20 illustrates the way in which the data within the database can be used in a transactional based system; and

FIG. 21 illustrates the way in which the data within the database can be analysed to identify key-man vulnerabilities within an organisation.

### OVERVIEW

FIG. 1 illustrates a computer system 1 in which the invention is implemented. The computer system includes a database 3 that can be accessed by a number of servers 5—two of which are shown in FIG. 1 and labelled 5-1 and 5-2. The database 3 is illustrated here as a single database 3, although in practice, multiple versions of the database 3 may be provided in the normal way to facilitate access and use thereof in different geographical regions. Users of the system wishing to gain access to the database 3 do so via a user terminal 7, which may be a fixed terminal such as a personal computer or a mobile terminal such as a cellular telephone or a laptop computer. FIG. 1 shows various different user terminals 7, labelled 7-1 to 7-7. As shown, user terminal 7-1 is able to access the database 3 via the server 5-1 and the Local Area Network 9-1; user terminals 7-2 to 7-4 are able to access the database 3 via the server 5-2, the Internet 11 and Local Area Network 9-2; user terminal 7-5 is able to access the database 3 via the server 5-2 and the Internet 11; user terminals 7-6 and 7-7 (which are mobile terminals) 1 are able to access the database 3 via the server 5-2, the Internet 11 and the telephone network 13. FIG. 1 also shows that user terminal 7-7 can directly connect to the Internet 11 and so can also access the database 3 via the server 5-2 and the Internet 11.

As will be explained in more detail below, the database 3 maintains data that defines multiple relationships between entities. As will become apparent from the use scenarios later, the entities may be individuals, companies, associations and the like. In the preferred embodiment described below, the entities are individual users and the database 3 also maintains a reputational score associated with each relationship and allows other users to increase (vote-up) the score associated with a relationship or to decrease (vote-down) the score. In this way, the reputational score associated with the relationship is crowd sourced (defined by the community of other users of the system) rather than sourced or controlled by the users that have the relationship. The reputational score allows users to search the database for particular users or for a particular expertise and allows the computer system to rank the search results to identify the entity or entities most relevant to the search.

A more detailed description will now be given of the database 3, the servers 5 and the user terminals 7.

### Database

The data maintained in the database 3 defines an interconnected graph of nodes, each node representing a different entity known to the system and the relationships between the entities are defined by links connecting the corresponding nodes in the graph. Such an interconnection between two nodes is illustrated graphically in FIG. 2. In this example, node 15-1 is associated with user “Scott” and node 15-2 is associated with user “Bill”. As shown, Scott and Bill are connected by multiple links 17-1 to 17-7. The links 17 are directional in nature, with links 17-1 to 17-3 extending from Scott to Bill and links 17-4 to 17-7 extending from Bill to Scott. Each link 17 defines a relationship between Scott and Bill and has a tag 19 that is user defined and that describes the reason for the relationship. In this embodiment, links 17 that extend away from a node 15 are created by the user associated with the node 15 from which the links extend. Thus Scott created links 17-1 to 17-3 and created tags 19-1 to 19-3 defining the reasons for the different relationships between himself and Bill. Similarly, Bill created links 17-4 to 17-7 and created tags 19-4 to 19-7 that effectively define his reasons for the relationships between himself and Scott. As illustrated in this example, the reasons why Scott is connected to Bill are not necessarily the same as the reasons why Bill is connected to Scott.

In the preferred embodiment described below, a reputational score is maintained for each relationship (link 17) and other users are able to increase (vote-up) the score associated with a link 17 or to decrease (vote-down) the score. In this way, the reputational score associated with the link 17 is crowd sourced (defined by the community of other users of the system) rather than the users that have the relationship. In the preferred embodiment, the reputational scores are also weighted by a decaying weighting function that helps to differentiate meaningful and crowd verified relationships from others that might otherwise limit the scalability of the computer system 1. In this embodiment, the size of the circle representing each tag 19 shown in FIG. 2 depends on the reputational score associated with the corresponding link 17. Thus link 17-3 has a larger reputational score associated with it than link 17-1; and link 17-1 has a larger reputational score associated with it than link 17-2 etc.

FIGS. 3a to 3d illustrate in more detail some of the data that is maintained in the database 3, in this embodiment. For ease of explanation, the data is illustrated in FIG. 3 in tabular form, but in practice, the data may be grouped together in appropriate fields or entries of a relational database. FIG. 3a illustrates node data 21 held for a node 15 within the database 3. As shown, the node data 21 includes a node ID 21-1 that defines a unique identifier for the entity (in this case person) associated with the node 15. Thus for node 15-1 shown in FIG. 2, the associated entity is Scott Brown and the node ID 21-1 that is stored in this case is the URI (Universal Resource Identifier) www.hsbc.com/scottbrown that points to a home page for Scott Brown. The node data 21 also includes the name 21-2 of the entity associated with the node; an email address 21-3 for Scott; a created date 21-4 that defines when the node 15-1 was created; a modified date 21-5 that defines when the node data 21 was last updated; a country code 21-6 defining the country in which Scott resides and a town code 21-7 that defines the city in which Scott is located. The node data 21 may omit some of this data and/or it can include additional data such as Scott's home, work and/or mobile telephone numbers etc.

FIG. 3b illustrates link data 23 maintained in the database 3 for the links 17-3 shown in FIG. 2. As shown, the link data 23 includes a link ID 23-1, in this case also a URI; a “from node ID” 23-2 that identifies the node 15-1 from which the link 17 extends; and a “to node ID” 23-3 that identifies the node 15-2 to which the link 17 extends. In this embodiment, the link ID is unique over all the links 17 that extend from the node 15 identified by the “from node ID” 23-2. Thus a link 17 is uniquely defined by a combination of its link ID 23-1 and the from node ID 23-2. The link data 23 also includes a created date 23-4 indicating when the link 17 was created and a modified date 23-5 indicating when the link 17 was last updated. The link data 23 also includes a tag ID 23-6 that points to tag data for the tag 19 associated with the link 17; and a reputational score 23-7 defining the crowd sourced score for that link 17.

FIG. 3c illustrates the tag data 25 maintained in the database 3 for the tag 19-3 associated with link 17-3. As shown, the tag data 25 includes the tag ID 25-1 (which in this embodiment is also a URI—and is the same as the tag ID 23-6) that identifies the particular tag; a tag description 25-2 that is a user defined text field that describes the reason for the relationship (link 17) with which the tag 19 is associated; a created date 25-3 indicating when the tag 19 was created; and optionally a URI relating to the tag 19. For example, if the tag 19 relates to a book, then the URI may be a link to a review of the book or the ISBN number of the book etc.

Finally, FIG. 3d illustrates vote data 27 that is maintained in the database 3 for each vote that is made against a link. As shown, the vote data 27 includes a vote ID 27-1 that uniquely identifies the link to which the vote relates. In this embodiment, as the link IDs 23-1 may not be unique over the entire system, the vote ID 27-1 is defined by the combination of the link ID 23-1 and the node ID 21-1 for the node 15 from which the corresponding link 17 extends. Thus if a user has entered a vote to increase the reputational score associated with link 17-2 shown in FIG. 2, then the vote ID 27-1 would be defined by the combination of the link ID 23-1 associated with link 17-2 and the node ID 21-1 associated with node 15-1. The vote data 27 also includes a voter node ID 27-2 that identifies the node ID 21-1 associated with the entity that made the vote. Finally, the vote data 27 includes the vote 27-3. In this embodiment, each entity is allowed to vote up the reputational score on each link 17 by +1. If they have already voted on a link, then they can also remove their vote by voting again with a score of −1. The vote data 27 is used, therefore, to keep track of all the votes that have been made by each user and for each link 17. In this embodiment, each time that a new vote is added to the system, the reputational score 23-7 associated with the link 17 to which the vote relates is updated to reflect the new vote.

### User Terminal

FIG. 4 is a block diagram illustrating the main components of the user terminals 7 that are used in this embodiment. As shown, the user terminal 7 includes a network interface 71 for interfacing with a communication network over which users can access the server 5 and database 3. The user terminal 7 also includes a processor 73 that controls the operation of the user terminal 7 in accordance with software instructions stored in memory 75. The user terminal 7 also has a user input device 77, such as a keyboard, touch-screen and/or mouse etc, via which the user can input navigation commands and other control inputs; and a user output device 79, which in this embodiment is a display for displaying information obtained from the database 3 via the server 5.

As shown in FIG. 4, the software stored in memory 75 includes an operating system 81 that defines the general operation of the user terminal 7 and a browser 83 that is used to provide the user interface with the server 5 and ultimately the data maintained in the database 3.

### User Terminal Operation

The way in which the user terminal 7 operates will now be described in more detail, illustrating the way in which users can access and search the data stored within the database 3, to make new connections within the database 3 and to modify the reputational scores 23-7 associated with other user's links 17.

FIG. 5 illustrates a web browser screen 91 generated by the browser 83 and displayed on the display 79 of the user terminal 7. In the left hand window 93, a login box 95 is provided via which users can login to the server 5 and database 3. In this illustration, the user Scott Brown has logged in and, in the right hand window 97, a graphical illustration 99-1 of part of the data stored in the database 3 is presented. In particular, when Scott logged in to the server 5, a login request (that includes Scott's user name) was sent from the browser 83 to the server 5. In response to receiving the login request, the server 5 uses Scott's user name to retrieve all of the connections associated with Scott or if Scott has more than ten connections, retrieves his top ten connections, for display in the right hand window 97. The server 5 ranks Scott's connections (to identify the top ten) based on the sum of all of the reputational scores associated with the links 17 that connect Scott to each of his connections. Thus, the overall reputation between say, Scott and Bill, is defined by the sum of all the reputational scores for links 17-1, 17-2 and 17-3 shown in FIG. 2. This overall reputation can then be ranked against similar overall reputations between Scott and his other connections.

As shown in FIG. 5, in this illustration, the server 5 retrieves node data for ten other users: Lyn, Paul, Bill, Aden, Dan, David, Anna, Tom, James and Randy. Each of these other users, together with Scott, are graphically represented within the window 97 by a node 15 (and labelled 15-2 to 15-11). As shown, Scott's node 15-1 is connected to the other nodes 15 by a respective connecting line (labelled 101-2 to 101-11). In this embodiment, the thickness of the connecting lines 101 depends on the overall reputational score between Scott and the corresponding user. Thus, in this example, the connecting line 101-8 between Scott and Randy is thick, which illustrates that the reputational scores associated with the links connecting Scott with Randy are relatively high in value. Conversely, the connecting line 101-9 between Scott and Lyn is very thin, illustrating that the reputational score associated with the links connecting Lyn with Scott are relatively low in value.

As mentioned above, in this embodiment, when a user logs in to the server 5 a subset of their connections will typically be illustrated in the main window area 97. This is to prevent the main window area 97 from becoming over cluttered or difficult to read. If a particular connection is not illustrated within the main window 97, then Scott can search for a contact using the searching window 103. As shown, Scott can search for users based on name by entering one or more characters from the user's name into the text box 105. Scott can also search the tag descriptions 25-2 contained in the database 3 by entering text into the text box 107. Scott can also limit the connections that are currently displayed in the main window 97 based on a specified tag description by selecting a tag description from a pull down menu box 109 of the filter window 110. In this way, only connections that are linked to Scott by a specific tag description will be shown in the window area 97.

### Name Search

The operation of the name search will now be described in more detail. If Scott starts to type text into the name search text box 105, then a name search request together with the characters input by Scott is sent to the server 5. The name search request also includes an identifier for Scott (either Scott's user name or an appropriate session identifier). In response to receiving the name search request, the server 5 uses the entered text to identify matches in the name field 21-2 of the node data 21. Names that match the text input are then transmitted back to the user terminal 7 for display within the main window 97. The number of names returned may be limited to, for example, the top one hundred names (where the ranking of the names may be done based on the reputational scores associated with the users). FIG. 6 shows the resulting user interface that is displayed by the browser 83 in response to Scott typing in the text “KEN” within the name search text box 105. As shown, in this embodiment, the browser 83 displays the matching names in a cloud 111 where the different names are displayed in a random pattern with different sizes and where the size and position of the different names change over time. In an alternative implementation, the retrieved names may simply be displayed as a list of names for selection by the user. If Scott identifies the name of the person he is searching for, then he can select the displayed name using the user input device 77. In response, the browser 83 sends a request back to the server 5 for the node data (connections) associated with the selected name. In response, the server 5 will search the database 3 to retrieve the top ten connections associated with the selected user and return appropriate data to the user terminal 7 for display by the browser 83.

FIG. 7 illustrates the graphical representation 99-2 of the connections that are retrieved and displayed within the main window 97 if Scott selected “Kendy Lu” from the user interface shown in FIG. 6. As shown in FIG. 7, the graphical representation 99-2 of Kendy's connections is similar to the graphical representation 99-1 of Scott's connections shown in FIG. 6. When presented with Kendy's connections, Scott is able to view contact details (such as email addresses, telephone numbers etc) for each of the users by clicking on the user's node 15. Scott is also able to view the links 17 that connect Kendy with each of her contacts by selecting the corresponding connecting line 101. For example, if Scott selects connecting line 101-13 (which connects Kendy with Sue) then a request is sent to the server 5 requesting the link data 23 for all of the links 17 connected Kendy with Sue. This data is returned to the browser 83 which then displays the connected graph in the main window 97, as shown in FIG. 8. As shown, in this example, Kendy has two links 17-8 and 17-9 that connect her with Sue (and Sue has no links connecting her with Kendy). Link 17-1 has a tag description “mcommerce” and link 17-9 has a tag description “legal”.

### Voting

When viewing the links 17 shown in FIG. 8, Scott may know from previous dealings with Sue that Sue is indeed an expert in relation to legal matters. Therefore, Scott may decide to vote up the reputational score associated with link 17-9. Alternatively, Scott may rely on Kendy's relationship with Sue to ask Sue for an opinion on a legal matter and if happy with the advice may also decide to vote up the reputational score associated with link 17-9. In either case, in this example embodiment, Scott can vote on the link 17-9 by using the input device 77 to hover a cursor (not shown) over the tag 19-9. This brings up the options illustrated in FIG. 9. As shown, three option buttons are provided—a vote button 131, an edit button 133 and a remove button 135. In this case, because the link 17-9 is not associated with Scott, the edit button 133 and the remove button 135 are deactivated (and may not be displayed). However, if Scott clicks on the vote button 131, then a vote up button 137 and a vote down button 139 are displayed which allows Scott to vote up or vote down the reputational score 23-7 associated with link 17-9. If Scott presses the vote up button 137 or the vote down button, then a message is sent from the user terminal 7 to the server 5 identifying the link 17-9 and the vote made by Scott. This message also includes an appropriate identifier for Scott so that the server 5 can identify Scott as being the voter.

As mentioned above, if Scott clicks on the edit button 133 or the remove button 135 shown in FIG. 9, then because the link 17-9 is not associated with Scott, the request to edit or remove the link 17-9 will be ignored by the server 5 and an appropriate error message will be returned and displayed to Scott on the main window 97. If, however, Scott is viewing the links 17 between himself and another user (such as the links 17 shown in FIG. 2), then he would be able to edit and remove any of those links, but he would not be able to vote on any of those links. In this way, for example, if Scott is not happy with a tag description Bill has used in one of the links 17-4, 17-5, 17-6 or 17-7 Bill created, then Scott can edit the tag description or remove the link.

### Add Link

Returning to FIG. 8, in addition to being able to view the links connecting Kendy with each of her displayed contacts, Scott can also add a link from his own node 15-1 to any of the connections that are displayed. Scott can do this, in this embodiment, by using the input device 77 to hover the cursor over the node 15 associated with the user with whom Scott wishes to make a connection. FIG. 10 illustrates what happens in this case when Scott hovers the cursor over Sue's node 15-13. As shown, a link button 141 and a remove button 143 are displayed connected to Sue's node 15-13. As the displayed graph shows the connections for Kendy, the remove button 143 is deactivated so that Scott cannot remove Sue from Kendy's connections. However, when Scott is viewing his own connections (shown in FIG. 5) then he can remove connections using this remove button 143. Therefore, in this example, if Scott does press the remove button 143, then the server 5 will ignore the request and send an error message back to the user terminal 7 for display in the main window 97.

On the other hand, if Scott clicks the link button 141, then the web browser 83 will send a request to the server 5 indicating that Scott (the currently logged in user) wishes to add a link between himself and Sue. The browser will then display a text box prompting Scott to enter a textual description for use as the tag description 25-2 for the new link 17 to be created and this textual description is then sent back to the server 5 once entered. With this information, the server 5 is able to generate new link data 23 and tag data 25 for the new link, which it stores within the database 3. Initially, the reputational score 23-7 associated with this new link is given a nominal starting value (such as the value 1).

### Tag Search

As discussed above, in addition to being able to search for other users or entities using the name search text box 105, Scott is able to search the database 3 based on text input into the tag search text box 107. In particular, when Scott starts entering text into the tag search text box 107, a tag search request is sent to the server 5 together with the text entered in the text box 107, which is to be searched against the tag descriptions 25-2 stored in the database 3. Matching text descriptions are then returned to the user terminal 7 for display by the browser 83. FIG. 11 illustrates the resulting tag descriptions that are displayed when Scott enters the text “COM” in the tag search text box 107. As shown in FIG. 11, the tag descriptions are displayed in a cloud 151 with the different tag descriptions having different sizes and whose positions and sizes change over time. Alternatively, the tag descriptions may simply be provided in a list within the main window 97. If Scott uses the input device 77 to select one of the displayed tag descriptions (such as the tag description “mcommerce”) then the browser 83 sends a request back to the server 5 to identify the entity within the database 3 having the highest reputational score associated with the tag description “mcommerce”—the expert or “Maven” associated with this tag description. In response, the server 5 searches the database 3 to identify this Maven and retrieves and returns node data for the top ten connections for this Maven. In this way, the requesting user (in this case Scott) can see the Maven and their top ten connections. FIG. 12 illustrates the situation where the identified expert is Sue and accordingly, FIG. 12 illustrates the top ten connections for Sue.

FIG. 12 also illustrates that if Scott hovers the cursor over Sue's node 15-13, a trace option button 155 is displayed, which, if selected, sends a request to the server 5 to search the connections within the database 3 to trace a path back to the logged-in user, Scott. In response to receiving such a trace request, the server 5 searches the database 3 to identify the shortest number of connections between Scott and Sue. Appropriate node data is then sent back to Scott's user terminal 7 for display by the web browser 83. FIG. 13 illustrates the result of this trace operation when the server 5 establishes that Sue and Scott have a shared connection with Bill. As shown, Sue's displayed graph 99-3 has been modified to show the connection to Scott through Bill. With this additional information, Scott is able to make a connection with Sue leveraging the relationship that he already has with Bill. In an alternative embodiment, the server 5 may perform the trace automatically in response to a tag search—so that Scott is presented with the graph shown in FIG. 13 initially without first showing the graph in FIG. 12 and requiring Scott to click the trace button 155.

### Server

A more detailed description will now be given of the server 5 and the way in which it operates to perform the various functions discussed above. FIG. 14 is a block diagram illustrating the main components of the servers 5 that are used in this embodiment. As shown, the server 5 includes a network interface 31 for interfacing with a communication network over which users can access the server 5 using a user terminal 7. The server 5 also includes a database interface 33 that allows the server 5 to connect to and retrieve data from, and store data in, the database 3. The server 5 also includes a processor 35 that controls the operation of the server 5 in accordance with software instructions stored in memory 37. In this embodiment, the server 5 is coupled to a user input device 39, such as a keyboard or mouse etc, and a user output device 41, such as a display and these can be used for maintenance or diagnostic purposes.

As shown in FIG. 14, the software stored in memory 37 includes an operating system 43 that defines the general operation of the server 5; a user login module 45 that allows users to login to the server 5; a search module 47 that retrieves data from the database 3 based on login details or user search queries; a user interface module 49 that generates appropriate user interface data for creating a user's view of the data retrieved by the search module 37 for output to the user via the user terminal 7; an add link module 51 that allows users to add a link within the database 3 connecting themselves to another user; an add node module 53 that allows a new user to be added to the database 3; a build module 45 that can automatically build node data 21 for a new user within the database 3 from the information held in other computer systems; a vote module 57 that allows users to vote on other user's reputational scores 23-7 associated with the links 17 connecting the corresponding nodes 15; an update module 59 that updates the data in the database 3 based on changes requested or votes made by users; and a link weighting calculation module 61 that calculates a time based weight to be applied to the reputational scores 23-7 associated with links 17 that are the subject of a search by the search module 47.

### Server Operation

The way in which the server 5 operates will now be described in more detail, illustrating the way in which the server 5 accesses and searches the data stored within the database 3, to make new connections within the database 3 and to modify reputational scores 23-7 associated with other user's links 17.

### Add Link

FIG. 15 is a flow chart illustrating the processing steps performed by the server 5 when a new link 17 is to be added to the database 3 between two entities. In step s1, the user interface module 49 of the server 5 receives a new link request, for example, as a result of a currently logged in user selecting the link button 113 via their web browser 83. The user interface module 49 recognises the new link request and passes the request to the add link module 51. The add link module 51 then processes the request in step s3 to determine the nodes 15 between which the new link 17 is to be added. In this embodiment, the add link module 51 is able to determine this information from the information contained in the new link request. In particular, the new link request includes a session ID that identifies the currently logged in user. The node ID 21-1 for the currently logged in user is used for the “from node ID” 23-2 for the new link 17. The new link request received from the user terminal 7 will also identify the node 15 over which the currently logged in user hovered and then selected the link button 141. The node ID 21-1 for this node 15 is used for the “to node ID” 23-3 for the new link 17. If the new link request received from the user terminal 7 does not include the required information, then the add link module 51 can ask the user interface module 49 to send an appropriate prompt to the user terminal 7 to gather the required information. If the new link is to be made to a new user, then the Add node module 53 is called to create node data 21 for the new user before the new link is created.

Once the add link module 51 has the information identifying the “from node” and the “to node” for the new link, the add link module 51 instructs the user interface module 49 to send a prompt, in step s5, to the user for a tag description 25-2 to be used for the new link 17. Once the tag description has been received back from the user terminal 7, the add link module 51 creates, in step s7, new link data 23 and, if appropriate, new tag data 25 for the new link 17. In particular, the add link module 51 will create a new link ID 23-1 for the new link; it will add the from node ID 23-2 and the to node ID 23-3 determined in step s3 and will set the created date and the modified date to the current date; it will add a tag ID to point to the tag data 25 associated with the new link 17 and it will set the reputational score 23-7 to an initial value. Each tag description that is added may be treated as a separate tag. However, since many users will use the same tag descriptions as others, the tag ID added to the link data 23 for the new link will preferably point to existing tag data 25 associated with the same tag description if it has been used before. However, if the tag description is new, then the add link module 51 will also generate new tag data 25 for the new link 17. In this case, the add link module would generate a tag ID 25-1 for the new tag and add the tag description 25-2 using the tag description obtained in step s5. The add link module 51 would also set the created date 25-3 and any URI to be associated with the tag that is entered by the user together with the tag description.

Once the add link module 51 has created the link data 23 (and if necessary the tag data 25) for the new link 17, it stores this data, in step s9, in the database 3. The add link module 51 then instructs the user interface module 49 to update the user's view of the database 3 which is currently displayed to the user in the main window 97 of their user device 7 to reflect the presence of the new link 17. As shown in FIG. 15, the user interface module 49 performs this update of the user view in step s11 and the processing then ends.

### Tag Search

The operation of the server 5 during a tag search operation will now be explained with reference to FIG. 16. As explained above, the tag search operation is performed when a currently logged in user enters text into the tag search text box 107. As shown, the operation starts in step s21 when the user interface module 49 receives the tag search request together with the text that the user has input in the text box 107. The user interface module 49 interprets the received request and passes the request to the search module 47. In response, the search module 47 uses the text in the received tag search request to identify, in step s22, the tag IDs 25-1 for the tag descriptions 25-2 that contain the input text. In step s23, the search module 47 passes the matching tag descriptions 25-2 to the user interface module 49 so that they can be returned to the user terminal 7 for display to the user. Once the user selects a displayed tag description 25-2, the selected tag description is returned to the server 5 and in step s25 the search module 47 uses the tag ID 25-1 associated with the selected tag description 25-2, to identify the corresponding links 17 in the database 3 that contain that tag ID 25-1 (i.e. the link data 23 that have a tag ID 23-6 matching the tag ID 25-1 associated with the selected tag description). The search module 47 then retrieves the reputational score 23-7 associated with the links 17 that contain the tag ID for the selected tag description together with the modified date 23-5 for each of those links.

The search module 47 then passes the modified date for each matching link to the link weighting calculation module 61 which uses the modified date to calculate, in step s27, a respective weighting for the corresponding reputational score 23-7. The link weighting calculation module 61 then returns the determined weightings back to the search module 47 which applies the determined weighting to the corresponding reputational score in step s29. As will be explained in more detail below the weighting is applied so that the weighted reputational score decays over time since the corresponding reputational score was last updated. Therefore the link weighting calculation module 61 calculates the weighting for each reputational score based on the difference between the current date and the date that the associated link was last updated (defined by the modified date 23-5).

In this embodiment, the weighting that is generated by the link weighting calculation module 61 has a value between 0 and 1 and the search module 47 applies the weighting to the corresponding reputational score 23-7 by multiplying the reputational score 23-7 with the weighting. As those skilled in the art will appreciate, in alternative embodiments, the weighting that is determined and then applied to the reputational score may be added or subtracted from the reputational score 23-7 or the reputational score 23-7 may be divided by the determined weighting.

Once the weighted reputational scores have been determined, the search module 47 aggregates and ranks, in step s31, the matching links based on the weighted reputational scores. In particular, the weighted reputational scores 23-7 associated with the same user (determined by identifying links having the same “to node ID”) are combined to define an aggregated reputational score relating to the selected tag description for that user. The aggregated reputational scores for the different users are then ranked so that users having a higher aggregated reputational score are ranked higher than users with a lower aggregated reputational score. In step s33, the search module 47 then retrieves the top ten connections from the database 3 for the user (expert) having the highest aggregated reputational score, which it passes to the user interface module 49 for sending to the user terminal 7. In step s35, the user interface module 49 determines whether or not a trace request has been received from the user terminal 7. If it has not, then the processing ends. If a trace request has been received, then in step s37, the search module 47 searches the database 3 to identify a minimum number of connections that would link the logged in user with the user having the highest aggregated reputational score (i.e. the expert). Node data for these intermediate connections are then passed to the user interface module 49 for transmission back to the user terminal 7 for display to the logged in user for use in establishing a connection with the identified expert.

In this way, the searching user is able to search the database 3 in order to identify the user having the highest reputational score associated with the tag being searched. Further, since the reputational score is accumulated through voting by other users, the reputational score is “crowd sourced” and over time will provide a good indication of the recognised expertise of the user to which the reputational score relates.

### Voting

As discussed above, in this embodiment, other users of the system are able to vote up and vote down the reputational score 23-7 associated with a link 17 connecting two other users. The way in which the server 5 controls this voting is illustrated in FIG. 17. As shown, in step s41, the user interface module 49 receives a vote request which it processes and then passes to the vote module 57. The vote module 57 then processes the received vote request, in step s43, to identify the link 17 to which the vote relates. In particular, the vote request received in step s41 is generated when the user clicks the vote button 131 shown in FIG. 9. As discussed above, the vote button 131 is displayed when the user hovers over the corresponding tag 19 associated with a specific link 17. Therefore, when the user clicks on the vote button 131, the browser 83 can identify the link 17 to which the vote relates. This link information is included in the vote request that is then transmitted to the server 5 and received in step s41. In step s43, the vote module 57 uses the link information in the received vote request to identify, from the corresponding link data 23 stored in the database 5, the “from node ID” 23-2 and the “to node ID” 23-3 associated with the selected link 17.

In step s45, the vote module 57 checks if the user that transmitted the vote request corresponds to either the “from node” or the “to node” identified in step s43. If he does, then the processing ends (because users are not allowed to vote on their own links) and an appropriate error message is sent back to the user terminal 7 from which the vote request was received. Otherwise, the processing proceeds to step s47, where the vote module 57 waits for the user to select the vote up button 137 or the vote down button 139. Once the vote has been received, the vote module 57 checks to see if the vote is valid in step s49. In particular, in this embodiment, each user is only allowed to vote up the reputational score 23-7 of a link 17 by a total of +1 and is only allowed to vote down a reputational score 23-7 in order to revoke a previous vote. Other restrictions or limits could of course be defined. In this embodiment, the vote module 57 checks to see if the vote is valid by searching the database 3 to identify previous votes that the same user has previously made in respect of the current link 17. If the vote is not valid, then the processing ends and an appropriate error message is returned to the user terminal 7 from which the vote was received. If the vote is valid, then at step s51, the vote module 57 stores new vote data 27 in the database 3. As shown in FIG. 3d, the vote data 27 includes the a vote ID 27-1 that uniquely identifies the link 17 to which the vote relates; the voter node ID 27-2 that identifies the voting user; and the vote 27-3 that identifies the value of the vote—i.e. whether it is a vote up or a vote down. At step s51, the vote module 57 also re-sets the modified date 23-5 stored in the corresponding link data 23 and increments or decrements the corresponding reputational score 23-7 for the link. The processing then ends with the user interface module 49 providing a corresponding vote complete confirmation back to the voting user.

### Name Search

The operation of the server 5 during a name search operation will now be explained with reference to FIG. 18. As explained above, the name search operation is performed when a currently logged in user enters text into the name search text box 105. As shown in FIG. 18, the name search operation starts at step s61 where the user interface module 49 receives the name search request. The user interface module 49 processes the name search request to determine that it should be passed to the search module 47. In step s63, the search module 47 searches the database 3 to identify names 21-2 that contain text matching the text contained within the name search request. The matching names identified by the search module 47 are then passed to the user interface module 49 which outputs the matching names in step s65 back to the user terminal 7 for display to the user. If more than a hundred names are identified, then the search module 47 will aggregate the weighted reputational scores 23-7 (in the manner discussed above) for all links associated with the matching names and will then send the names of the top one hundred users having the highest aggregated reputational scores. The processing then waits in step s67 until the user selects one of the displayed names. When the user selects one of the displayed names, the selected name is received by the user interface module 49 and passed to the search module 47. In step s69, the search module 47 retrieves all the connections (other users) from the database 3 that are associated with the selected name. In step 71, the search module 47 determines, for each connection, an aggregated (weighted) reputational score for all the links connecting the selected name with that connection. For example, if the selected name is Kendy and the other connection is Sue, then at step s71, the search module 47 adds up all of the weighted reputational stores 23-7 associated with the links that connect Kendy to Sue.

In step s73, the search module 47 then ranks the connections based on the aggregated reputational scores that are determined in step s71 for the different connections. The search module 47 then passes the connection data for the top ten connections associated with the selected name to the user interface module 49 which returns the connection data, in step s75, to the user terminal 7 for display to the user. As those skilled in the art will appreciate, a similar procedure is performed when a user logs-in to the server 5. In this case, the user login module 45 validates the credentials of the user, and once validated, instructs the search module 47 to retrieve the top ten connections for the user that has logged in. A detailed description of the log in procedure will therefore be omitted.

### Weight Function

As explained above, the link weighting calculation module 61 calculates a respective time dependent weighting to be applied to each reputational score 23-7. This weighting of the reputational scores is performed when trying to identify an expert relating to a specific tag description. It is also performed prior to ranking the connections when the server is identifying the top ten connections to be displayed to the user on the user terminal 7. As explained above, the purpose of the weighting that is applied is to de-emphasise (or reduce the importance of) links that have not been modified for a long time. FIG. 19a illustrates the form of one weighting function 161 that can be used to calculate the different weightings. As shown, the weighting function preferably includes a constant portion 163 where the weighting does not change. This constant portion may last for a day or a week but preferably for a month following the last updating of the corresponding reputational score. At the end of this constant weighting portion 163, the weighting function then decays exponentially to approximately zero after about 12 months from when the reputational score was last updated. In this way, links 17 that are added to the database 3 that are not corroborated (voted on) by other users are unlikely to be taken into account in any search results reported back to a user.

The same weighting function may be used to calculate the appropriate weighting for each reputational score. Alternatively, different weighting functions may be applied depending on the user with whom the reputational score is associated. For example, a first weighting function may be used for users that are highly active in creating links with other users and a different weighting function may be used for users that are less active. FIG. 19b illustrates three different exponential weighting functions 161-1, 161-2 and 161-3 that may be used for three different classes or groups of user. In this case, before a weighting can be determined for a reputational score, the link weighting calculation module 61 also has to determine in which class or group the user with whom the reputational score is associated belongs. This information may be predefined within the database 3 or it may be determined based on the recent activity of the user. For example, the weighting function may be defined by the following equation:

y=e^{-x/(2.5-f)}

where x is the month number following creation or last modification of the reputational score (adjusted by one month to provide the constant weighting part 163); and f is an activity factor that is determined for each user based on their current level of activity within the database 3. The following different user groups can then be defined based on user activity as follows:
U0=lowest activity user creating on average zero connections per month
U1=low activity user creating an average two connections per month
U3=low/moderate user, creating five connections per month
Unorm=benchmark user, creating ten connections per month
U3=moderate/highly active user, creating twenty connections per month
U4=highly active user, creating fifty connections per month.

The activity factor (f) can then be defined, for example, by the following equation:

$$F = \frac{( \frac{\sum {U}_{cxn}}{\sum {U}_{bench\_cxn}} )}{scaling\_factor}$$

where the scaling factor is arbitrarily set to, for example, a value of ten. Thus, for moderate/highly active users creating twenty connections per month (U3), the activity factor, f, equals (20/10/10)=0.2 and therefore, the decay curve for users in group U3 is:

y=e^{-x/(2.3)}

Thus, the exponential decay of the weighting used for highly active users will be much steeper than the exponential decay of the weighting applied for low activity users. In this way, the weighting also acts as a normalising function so that the reputational scores do not become biased towards highly active users. If the same weighting function is used, then highly active users are more likely to become the “Mavens” just because they have many connections with many different users (which may all relate to the same tag description). With the weighting function described above, after approximately twelve months of inactivity (where no-one votes on the link), the weighting applied to the reputational score 23-7 will tend towards zero, regardless of the activity of the user with which the reputational score is associated.

### Advantages

The computer system and database described above have a number of advantages over existing databases and computer systems. A number of these advantages will now be explained.

In the system described above, users created links with other users and added a description explaining the reason for the link with the other user. This description relates to an attribute (such as knowledge, reputation or expertise) of the other user. Thus for example, referring to the graph shown in FIG. 2, Scott created the link 17-3 with Bill and included a tag description “project manager”. This tag description is chosen by Scott and defines an assessment made by Scott of an attribute that Bill possesses. Therefore, the database 3 captures other people's views of a particular user's attributes, rather than the more traditional database where Bill provides the information defining his own attributes.

Additionally, by only allowing other users to be able to vote up or vote down (revoke) the reputational scores associated with the links between two users, means that the reputational scores will be crowd verified and are thereby more likely to be accurate and trustworthy.

In the above embodiment, the reputational scores were weighted with a time dependent decaying weighting function in order to reduce the importance of links on which no other users voted or there has been little recent activity. This makes the system more scalable and able to operate with thousands if not millions of users and corresponding links. For example, links that are not being voted upon may be removed from the database after a predetermined period of time of inactivity.

As a result of the use of the reputational scores in order to rank search results, the system described above can identify crowd verified experts relating to a specific topic. The information that is retrieved is not, therefore, biased based on a particular user paying a searching company to place their search results ahead of the search results of other users.

In addition to providing a way to identify and connect with an expert on a particular subject, the system described above also allows users to find and then connect with other users having similar attributes.

These and other advantages will be apparent to those skilled in the art.

### System Applications

The computer system and database described above have a number of different uses and some of these applications will now be briefly described.

### Social Networking

The system described above can be used in place of or to augment existing social networking systems such as Facebook and LinkedIn. In particular, these existing sites already provide the ability to link and connect users with other users, and the system described above could be added to these existing social networking sites to allow users to build a more detailed view of their connections—providing multiple links between themselves and each of their connections, with each link defining an attribute of the person connected by the link and including a reputational score that can be voted on by other users. The resulting social networking system will then have the various benefits of the embodiment described above.

### Search

The system and database described above could be used to improve the searching facilities of existing internet search tools such as Google, Yahoo and the like. In particular, the system described above will allow users to be able to search for users or other entities having a particular attribute that has been verified by other users (through the use of the reputational score and the voting thereon by other users). A reputational score may also be provided for existing websites allowing websites also to be represented. Such a reputational score may be initialised based on previous browsing history of users. For example, if a user clicks through a search result to arrive at a website then the time taken for the user to return to the search page and click a subsequent search result is indicative of the relevance of the result to the original search. By tracking similar times for different users, a score can be determined for a website relating to how useful users find the page. This score could be used to initialise a reputational score for the website which can then be voted upon by other users.

### Transaction System

The computer system and database described above can also be used in a transaction based system. For example, FIG. 20 illustrates a scenario in which Scott buys a book from Amazon. If Scott likes the book, then he may choose to add a link 17-29 in the database 3 to a node 15-30 associated with Amazon, where the tag description 19-29 for the link 17-29 relates to the book. The tag description 19-29 may include, for example, a URI for the book such as a link to the relevant page on the Amazon website or the ISBN number for the book. Other users may know and respect Scott's opinion with regard to books and, upon seeing Scott's recommendation of the book (by it's presence in the link 17-29 between Scott and Amazon) may themselves decide to purchase the book from Amazon. If Amazon sees that several users are buying the book because of Scott's recommendation, then Amazon may in turn create a link 17-30 with Scott and reward Scott with an appropriate monetary reward such as a book token or the like.

### Human Resource Tool

The computer system and database described above can also be used as a human resources tool in a large organisation. For example, the connections between users defined in the database can be processed to identify skills overlap between employees or to identify key personnel through which many connections in the organisations are made. If such a key person leaves the organisation then connections between the different groups of people may be seriously affected. This situation is illustrated graphically in FIG. 21 which shows two networks 171 and 173 of users 15 which are grouped based on the country in which the users reside. FIG. 21 also shows the connections between the users 15 and shows that only a single connection 175 is made between one user 15-42 in the US and one user 15-43 in the UK. If either of those users were to leave then the working relationships and connections between the users in the UK and the users in the US would be lost. Therefore, the data in the database 3 can be analysed in order to try to identify such key man risks and, once identified, steps can then be taken in order to try to mitigate the risk associated with these key personnel.

Various other applications and uses of the system described above will be apparent to those skilled in the art. What can be seen, however, is that the computer system described above offers a framework that allows the capturing and managing of reputation information that is crowd sourced and verified and that has a wide range of commercial uses.

### Modifications and Alternatives

An embodiment of a computer system and database was described above. A number of modifications and alternatives can be made to the system and database and a number of these modifications and alternatives will now be described.

In the above embodiment, the user terminal 7 used a web browser 83 in order to interact with the remote server 5 to access the data in the database 3. As those skilled in the art will appreciate, much of the functionality carried out in the server 5 could also be performed in the user terminal 7. For example, instead of the server 5 having the search module, user interface module, add link module, add node module, build module, vote module, update module and link weighting calculation module, one or more of these modules may be run on the user terminal 7. However, such an embodiment is not preferred as this will increase the overall data volume transmitted between the database and the user terminal. This will also increase the processing power required of the user terminals.

In the above embodiment, the computer system was described as having a number of user terminals, one or more servers and one or more databases. As those skilled in the art will appreciate, the functionality of the server and the database may be provided by a single computer terminal.

In the above embodiment, nodes, links and votes all had an associated identifier. The identifiers used were URIs. As those skilled in the art will appreciate, other types of IDs could of course be used.

In the above embodiment, each of the nodes in the database was related to a different user. As those skilled in the art will appreciate, the nodes may represent any entity, such as a company, an organisation or any association. Nodes may also represent other entities—such as book or a paper/article etc. For example, the author of an article may add a node to the article. This will allow others who review the article to add links to the article, with each being associated with a different attribute (and reputational score). So for example, some users may create a link to the article indicating that it is a recommended article on a first topic; and other users may add links to indicate that the article is recommended for other reasons. If the reputational scores for the same article are voted up by other users, then the article can become well known for different reasons and a score for each reason is maintained and can be used for discrimination purposes.

In the main embodiment described above, a particular user interface was described for allowing a user to view the data stored in the database 3. As those skilled in the art will appreciate, various different user interfaces may be provided that will allow a user to view the data stored within the database in a different manner.

In the embodiment described above, the user had to login to the system before they could interact and view the data stored within the database 3. In an alternative embodiment, the user does not need to login before interacting with the data. However, in this case, the user is preferably not able to vote on the links associated with other users in order to prevent users from voting on their own links. Where a login is required, the system may be able to use login information from other similar computer systems. For example, if the user is already logged in to their Facebook site, then the login credentials from the Facebook site may be used automatically as the login credentials for the system described above. In this way, the user does not need to type in any user name or other login details.

In the above embodiment, an exponentially decaying weighting function was applied to each of the reputational scores. In a simpler version of the system, such an exponential weighting function may not be used.

In the embodiment described above, the weightings used to weight the reputational scores were calculated at a time that the search was made on the database 3. Alternatively, the database 3 may automatically calculate the relevant weightings at intermittent periods for all of the reputational scores and apply those weightings accordingly. In this case, when a search is made, the current weighted reputational score can simply be read out from the database and ranked accordingly. However, such an embodiment is not preferred as this will require calculation of weightings that may never actually be needed.

In the above embodiment, users were able to vote on the reputational score associated with a link. Each user was only able to increase the reputational score by one. In an alternative embodiment, users may be able to increase the reputational score by varying amounts depending on the class of user. For example, highly active users may be allowed to increase the reputational score by a larger amount than less active users. For example, active users may be allowed to increase a reputational score by a value up to ten, whereas less active users may only be able to increase the reputational score by a value up to five.

In the above embodiment, the server performed various checks to make sure that votes are valid or that the voter is not voting on their own link. As those skilled in the art will appreciate, these checks could be effectively built into the user interface presented to the user on the user terminal 7. For example, the vote button may not be displayed when the user hovers over any of their own links. This would thereby prevent users from voting on their own links. Similarly, if a user has already voted on a particular link, then the vote up button associated with that link may be disabled for that user.

In the above embodiment, various user options and controls were activated by the user hovering over nodes or tags or by clicking various elements in the user interface. As those skilled in the art would appreciate, other techniques can be used to allow the user to make selections or activate options within the user interface. For example, if the user terminal has a mouse that has left and right buttons, then options can be selected by left clicking on the relevant item displayed in the user interface and menu options can be displayed by righting clicking in a appropriate portion of the user interface.

In the embodiment described above, vote data for each vote that is made by the different users is stored within the database 3. This allows the database to be able to recalculate all of the reputational scores and to check if a user has previously voted on the link to which a new vote relates. However, it is not essential to store the vote data in the database. Instead, the database may simply maintain the running total of the reputational score and may include data associated with each user identifying the links on which they have already voted.

The data generated and stored in the database also provides a rich source of user information that can be processed to determine user profile data for the different users in the database. This profile information can then be used to control advertising or marketing to those users in the normal way.

In the above embodiment, when a user performed a tag search, the server searched the database to find the user having the highest reputational score associated with the tag description. In alternative embodiments, the server may search the database to identify, for example, the five users (or entities) having the highest reputational scores associated with the tag description being searched. Providing information for a number of different potential experts makes it easier for the user to identify a link between himself and one of the experts. The user is then able to choose an appropriate expert to contact.

In the above embodiment, the server 5 was able to add links (and nodes) to the database and perform searches in the database 3. In another embodiment, different servers may be provided for doing different tasks. For example, one server may perform all searches whilst another server adds new data into the database 3.

In the above embodiment, users were able to search the database for different purposes. As those skilled in the art will appreciate, searches may be carried out in response to search requests issued by other computer systems.

These and other modifications and variations will be apparent to those skilled in the art and a further description thereof will there be omitted.

1. A computer system comprising:
a computer server;
one or more user terminals; and
a database of computer entries, each computer entry including node data defining a node representative of an entity and link data defining a plurality of links connecting the node to one or more other nodes representative of one or more other entities, each link having associated tag data that describes an attribute of one of the entities associated with the link and a reputational score associated with the attribute;
wherein the system is operable: i) to receive a search request; ii) to search the computer entries based on the received search request; iii) to rank search results based on reputational scores associated with the search results; and iv) to output one or more ranked search results.

2. A system according to claim 1, wherein each reputational score has an associated time dependent weighting.

3. A system according to claim 2, wherein the weighting applied to a reputational score reduces the reputational score relative to other weighted reputational scores.

4. A system according to claim 1, wherein entities are able to vote on the reputational scores stored within the database.

5. A system according to claim 4, wherein an entity associated with a node from which a link associated with a reputational score extends, is prevented from voting on that reputational score.

6. A system according to claim 5, wherein an entity associated with a node to which a link associated with a reputational score extends, is prevented from voting on that reputational score.

7. A system according to claim 4, wherein entities are able to vote up or vote down a reputational score.

8. A computer server comprising:
a processor operable to:
receive a search request from a user terminal;
search a database of computer entries based on the received search request, the database storing, for each computer entry, node data defining a node representative of an entity and link data defining a plurality of links connecting the node to one or more other nodes representative of one or more other entities, each link having associated tag data that describes an attribute of one of the entities associated with the link and a reputational score associated with the attribute;
rank search results based on reputational scores associated with the search results; and
output one or more ranked search results to the user terminal.

9. A server according to claim 8, wherein the processor is operable to calculate and apply a weighting for each reputational score associated with the search results prior to ranking the search results.

10. A server according to claim 9, wherein the weighting applied to a reputational score reduces the reputational score relative to other weighted reputational scores.

11. A server according to claim 10, wherein the weighting applied to a reputational score is defined by one or more exponential functions.

12. A server according to claim 9, wherein the weighting applied depends on the difference in time between when the search request is received and when the reputational score was last updated.

13. A server according to claim 9, wherein the weighting applied to a reputational score depends on the entity represented by the node from which the link associated with the reputational score extends.

14. A server according to claim 13, wherein entities are able to create links with other entities in the database and wherein the weighting applied to a reputational score depends on the number of links created in a given time period by the entity represented by the node from which the link associated with the reputational score extends.

15. A server according to claim 9, wherein the processor is operable to apply a constant weighting or no weighting to a reputational score for an initial period following an update of the reputational score.

16. A server according to claim 9, wherein the weighting applied to a reputational score is such that the reputational score is substantially reduced to zero after a defined period following the time when the reputational score was last updated.

17. A server according to claim 8, wherein the processor is operable to receive a vote for a reputational score from a voting entity and is operable to update the reputational score based on the received vote.

18. A server according to claim 17, wherein the processor is operable to prevent an entity associated with a node from which a link associated with a reputational score extends, from voting on that reputational score.

19. A server according to claim 17, wherein the processor is operable to prevent an entity associated with a node to which a link associated with a reputational score extends, from voting on that reputational score.

20. A server according to claim 17, wherein the processor is operable to identify the voting entity from login data associated with the voting entity.

21. A server according to claim 17, wherein entities are able to vote up or vote down a reputational score.

22. A server according to claim 21, wherein a limit is placed on the amount by which a given entity can vote up the reputational score, wherein the database is operable to maintain vote data for votes that have been made on reputational scores by an entity and wherein the processor is operable to check previous votes made by the voting entity to determine if said limit has been reached and thereby whether or not the reputational score should be updated in accordance with the vote.

23. A server according to claim 17, wherein each reputational score has an associated time stamp that indicates the last time that the reputational score was updated and wherein said processor is operable to update the time stamp in response to the voting up or the voting down of the reputational score.

24. A server according to claim 8, wherein the processor is operable to generate new node data and new link data in response to user inputs received from one or more user terminals.

25. A database comprising:
a plurality of computer entries, each computer entry including:
node data defining a node representative of an entity; and
link data defining a plurality of links connecting the node to one or more other nodes representative of one or more other entities, each link having associated tag data that describes an attribute of one of the entities associated with the link and a reputational score associated with the attribute.

26. A relationship management database comprising:
a plurality of computer entries, each computer entry including:
node data defining a node representative of an entity; and
link data defining a plurality of links connecting the node to another node representative of another entity, each link having associated tag data that describes a different relationship attribute of the other entity.

27. A method of searching a database according to claim 25, characterised by ranking search results using reputational scores associated with links matching a search query.

28. A method according to claim 27, comprising weighting the reputational scores prior to said ranking.

29. A method of updating the database of claim 27, comprising receiving a user vote relating to a link in the database and updating the reputational score associated with the link based on the user vote.

30. A social networking database comprising a database according to claim 25.

31. An internet search server comprising a server according to claim 8.

32. A computer terminal comprising:
a processor operable to:
receive a search request;
search a database of computer entries based on the received search request, the database storing, for each computer entry, node data defining a node representative of an entity and link data defining a plurality of links connecting the node to one or more other nodes representative of one or more other entities, each link having associated tag data that describes an attribute of one of the entities associated with the link and a reputational score associated with the attribute;
rank search results based on reputational scores associated with the search results; and
output one or more ranked search results to the user.

33. A computer system comprising:
a computer server; and
a database of computer entries, each computer entry including node data defining a node representative of an entity and link data defining a plurality of links connecting the node to one or more other nodes representative of one or more other entities, each link having associated tag data that describes an attribute of one of the entities associated with the link and a reputational score associated with the attribute;
wherein the system is operable: i) to receive a request to add a link from a first entity to a second entity; ii) to receive a description of an attribute of the second entity; iii) to initialise a reputational score associated with the new link; iv) to define tag data for the new link based on the received description of the attribute of the second entity; and v) to store link data for the new link in the database.

34. A computer implementable instructions product comprising computer implementable instructions for causing a programmable computer device to become configured as the server of claim 8.

35. A computer implementable instructions product comprising computer implementable instructions for causing a programmable computer device to become configured as the database of claim 25.

36. A computer implementable instructions product comprising computer implementable instructions for causing a programmable computer device to become configured as the terminal of claim 32.
